(19) United States
(12) Patent Application Publication
(10) Pub. No.: US 2021/0331886 A1
(43) Pub. Date: Oct. 28, 2021

(54) CONVEYING DIRECTION SWITCHING APPARATUS AND PAPER SHEET HANDLING APPARATUS

(71) Applicant: FUJITSU FRONTECH LIMITED, Tokyo (JP)

(72) Inventors: Tatsuya SHIMAMURA, Inagi (JP); Tetsuya ODAKA, Inagi (JP); Takashi WADA, Inagi (JP)

(73) Assignee: FUJITSU FRONTECH LIMITED, Tokyo (JP)

(21) Appl. No.: 17/369,431

(22) Filed: Jul. 7, 2021

Related U.S. Application Data
(63) Continuation of application No. PCT/JP2019/003317, filed on Jan. 31, 2019.

(51) Int. Cl. B65H 29/62; B65H 7/06; G07D 11/18

(52) U.S. Cl. CPC B65H 29/62; B65H 7/06; G07D 11/18; B65H 2301/44822; B65H 2404/632; B65H 2701/1912; B65H 2301/4455; G07D 2211/00

(57) ABSTRACT

A conveying direction switching apparatus includes a first switching gate that, at a joint portion of a first conveying path, a second conveying path, and a third conveying path, switches between a first conveyance route connecting the first conveying path and the second conveying path and a second conveyance route connecting the first conveying path and the third conveying path, a second switching gate that switches between the first conveyance route and a third conveyance route connecting the second conveying path and the third conveying path, and a free gate that is arranged on a same shaft as the first switching gate such that a second conveyance route side is opened by an elastic body at a joint portion of the second conveyance route and the third conveyance route.

### CROSS-REFERENCE TO RELATED APPLICATION

This application is a continuation application of International Application PCT/JP2019/003317, filed on Jan. 31, 2019 and designating the U.S., the entire contents of which are incorporated herein by reference.

### FIELD

The present invention relates to a conveying direction switching apparatus and a paper sheet handling apparatus.

### BACKGROUND

Conventionally, a paper currency handling apparatus, such as an automated teller machine (ATM) installed in a bank or the like or a cash machine installed in a back office in a store or the like, which handles a paper currency is known. The paper currency handling apparatus as described above switches between conveyance destinations in order to store paper currencies in different cassettes depending on denominations or conditions, for example. For example, if a conveying path is bifurcated in cassette directions, it is proposed to provide a conveying direction switching apparatus that switches between conveyance routes in three conveying paths. The conveying direction switching apparatus uses two switching claws and therefore is able to bifurcate the conveying paths in the cassette directions regardless of whether conveying directions of the conveying paths are oriented to any direction.

Patent Document 1: Japanese Laid-open Patent Publication No. 2016-081289

Meanwhile, in the paper currency handling apparatus, in some cases, a paper currency stuck (hereinafter, also referred to as a jam) may occur. The paper currency handling apparatus may have a function to, if a jam occurs, remove a stuck paper currency by performing operation of storing the stuck paper currency in a reject cassette and prevent interruption. In this operation, conveying directions in conveying paths in a linear direction may be opposite to each other at a bifurcated portion. However, in the conveying direction switching apparatus as described above, in some cases, paper currencies conveyed from both sides may crash into each other or may crash into the switching claws at the bifurcated portion. Further, if the switching claw for one of the conveying paths is prioritized, the paper currency remains on the other conveying path and may be crashed into by a next paper currency on the conveying path. Therefore, it is difficult to remove paper currencies on the conveying paths whose conveying directions are opposite to each other.

### SUMMARY

According to an aspect of the embodiments, a conveying direction switching apparatus includes: a first switching gate that, at a joint portion of a first conveying path, a second conveying path, and a third conveying path, switches between a first conveyance route connecting the first conveying path and the second conveying path and a second conveyance route connecting the first conveying path and the third conveying path; a second switching gate that switches between the first conveyance route and a third conveyance route connecting the second conveying path and the third conveying path; and a free gate that is arranged on a same shaft as the first switching gate such that a second conveyance route side is opened by an elastic body at a joint portion of the second conveyance route and the third conveyance route, wherein when conveying directions of the first conveying path and the second conveying path are opposite to each other, the first switching gate is switched to the second conveyance route side and the second switching gate is switched to a third conveyance route side.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating one example of a configuration of a paper currency handling apparatus according to an embodiment;

FIG. 2 is a diagram illustrating one example of a flow of paper currencies at the time of deposit;

FIG. 3 is a diagram illustrating one example of the flow of the paper currencies at the time of deposit;

FIG. 4 is a diagram illustrating one example of a flow of the paper currencies at the time of withdrawal;

FIG. 5 is a diagram illustrating one example of a flow of the paper currencies at the time of occurrence of a jam;

FIG. 6 is a side view illustrating one example of a conveying direction switching apparatus according to the embodiment;

FIG. 7 is a perspective view illustrating one example of the conveying direction switching apparatus according to the embodiment when viewed from a front side;

FIG. 8 is a perspective view illustrating one example of the conveying direction switching apparatus according to the embodiment when viewed from a back side;

FIG. 9 is a side view illustrating one example of an operating state of the conveying direction switching apparatus according to the embodiment;

FIG. 10 is a side view illustrating another example of the operating state of the conveying direction switching apparatus according to the embodiment;

FIG. 11 is a side view illustrating a still another example of the operating state of the conveying direction switching apparatus according to the embodiment; and

FIG. 12 is a side view illustrating a still another example of the operating state of the conveying direction switching apparatus according to the embodiment.

### DESCRIPTION OF EMBODIMENTS

Embodiments of a conveying direction switching apparatus and a paper sheet handling apparatus disclosed in the present application will be described in detail below based on the drawings. In the embodiments below, a case will be explained in which a paper currency is adopted as one example of a paper sheet and a paper currency handling apparatus is adopted as one example of the paper sheet handling apparatus, but the disclosed technology is not limited to this example.

### Embodiment

Configuration of Paper Currency Handling Apparatus

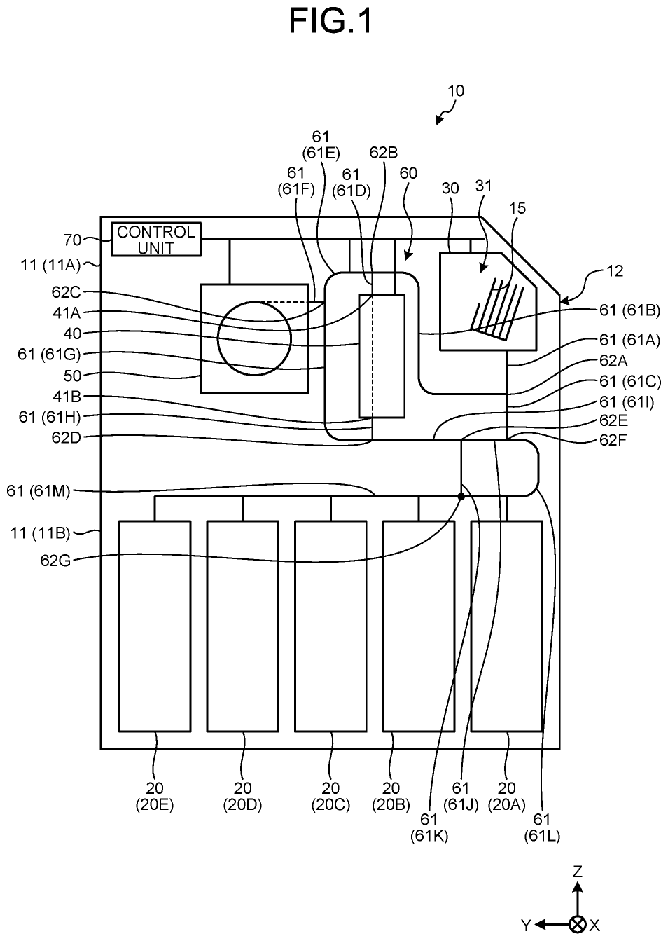

FIG. 1 is a diagram illustrating one example of a configuration of a paper currency handling apparatus according to an embodiment. A paper currency handling apparatus 10 is, for example, an apparatus, such as an ATM or a cash machine, which handles a paper currency.

The paper currency handling apparatus 10 is configured such that various units are detachably attachable thereto in order to ensure high scalability. The paper currency handling apparatus 10 is configured to be able to cope with various requests, such as deposit of a paper currency, withdrawal of a paper currency, or detailed examination on a paper currency, from customers by combining various units depending on equipped functions. For example, the paper currency handling apparatus 10 may be configured as an ATM or a cash machine by combining various units. FIG. 1 illustrates one example in which needed units are combined with basic functions, such as despite of a paper currency, withdrawal of a paper currency, and detailed examination on a paper currency, related to handling of a paper currency.

In the paper currency handling apparatus 10, a housing 12 is configured with a plurality of cases 11. For example, in the paper currency handling apparatus 10 according to the embodiment, the housing 12 is configured with an upper case 11A and a lower case 11B.

In the case 11A, a reception unit 30, a determination unit 40, and a temporary holding unit 50 are arranged. In the case 11B, a plurality of cassettes 20 are arranged side by side. In the present embodiment, five cassettes 20A to 20E are arranged side by side inside the case 11B.

The reception unit 30 receives at least one of deposit and withdrawal of a paper currency 15. For example, the reception unit 30 includes an operation panel (not illustrated) that receives various kinds of operation. Further, in the reception unit 30, a storage space 31 for storing the paper currency 15 that is deposited or withdrawn by the user is arranged.

The determination unit 40 determines a type of the paper currency 15. For example, the determination unit 40 includes two conveyance openings 41A and 41B and is configured such that the paper currency 15 is able to pass between the conveyance openings 41A and 41B. The determination unit 40 determines a type and authenticity of the paper currency 15 when the paper currency 15 passes between the conveyance openings 41A and 41B. For example, the determination unit 40 determines a denomination of the paper currency 15 as the type of the paper currency 15. Meanwhile, the determination unit 40 may determine a degree of a defect or dirt of the paper currency 15.

The temporary holding unit 50 temporarily holds the paper currency 15. For example, the temporary holding unit 50 is a winding type holding unit that includes a belt-like tape and a winding drum. When reeling in the tape by the winding drum, the temporary holding unit 50 is able to temporarily store the paper currency 15 by sandwiching the paper currency 15 between the tapes and extracting the stored paper currency 15 by rewind the tape from the winding drum.

The paper currency handling apparatus 10 includes a conveying mechanism 60 that conveys the paper currency 15 to the upper case 11A and the lower case 11B. The conveying mechanism 60 includes a conveying path 61 for moving the paper currency 15 inside the case 11A and the case 11B, and includes a motor, a roller, and the like (not illustrated) for moving the paper currency 15 along the conveying path 61. The conveying path 61 is bifurcated depending on paths to which the paper currency 15 is moved. Further, in the conveying path 61, a switching mechanism, such as a switching gate, for changing the conveying direction of the paper currency 15 is arranged at a bifurcation point at which the path is bifurcated, and it is possible to switch between paths in which the paper currency 15 is conveyed. Meanwhile, the bifurcation point may also be referred to as a joint portion of the conveying paths.

For example, a conveying path 61A is connected to the reception unit 30. The conveying path 61A is bifurcated into a conveying path 61B and a conveying path 61C at a bifurcation point 62A. The conveying path 61B is bifurcated into a conveying path 61D and a conveying path 61E at a bifurcation point 62B. The conveying path 61D is connected to the conveyance opening 41A of the determination unit 40. The conveying path 61E is bifurcated into a conveying path 61F and a conveying path 61G at a bifurcation point 62C. The conveying path 61F is connected to the temporary holding unit 50. The conveying path 61G is bifurcated into a conveying path 61H and a conveying path 61I at a bifurcation point 62D. The conveying path 61H is connected to the conveyance opening 41B of the determination unit 40. The conveying path 61I is bifurcated into a conveying path 61J and a conveying path 61K at a bifurcation point 62E. The conveying path 61J is bifurcated into the conveying path 61C as described above and a conveying path 61L at a bifurcation point 62F. The conveying path 61L is connected to an upper portion of the first cassette 20A, and bifurcated into the conveying path 61K and a conveying path 61M at a bifurcation point 62G. In the conveying path 61L, a branch to the first cassette 20A is arranged. The conveying path 61M is arranged above the second to the fifth cassettes 20B to 20E, and branches to the cassettes 20B to 20E are arranged.

In the conveying mechanism 60, the conveying paths 61B, 61C, 61E, 61G, 61I, and 61J form a loop. Further, in the conveying mechanism 60, the conveying paths 61J, 61L, and 61K form a loop.

The conveying mechanism 60 is able to convey the paper currency 15 from at least one of the two conveyance openings 41A and 41B of the determination unit 40 to an inside of the case 11B. For example, the conveying mechanism 60 is able to convey the paper currency 15 from the conveyance opening 41B to the inside of the case 11B by causing the paper currency 15 to pass through the conveying paths 61H, 61I, and 61K. Further, the conveying mechanism 60 is able to convey the paper currency 15 from the conveyance opening 41B to the inside of the case 11B by causing the paper currency 15 to pass through the conveying paths 61H, 61I, 61J, and 61L. Furthermore, the conveying mechanism 60 is able to convey the paper currency from the conveyance opening 41A to the case 11B by causing the paper currency 15 to pass through the conveying paths 61D, 61B, 61C, 61J, and 61K. Moreover, the conveying mechanism 60 is able to convey the paper currency 15 from the conveyance opening 41A to the case 11B by causing the paper currency 15 to pass through the conveying paths 61D, 61B, 61C, and 61L.

The conveying mechanism 60 is able to convey the paper currency 15 between the reception unit 30 and the plurality of cassettes 20 via the determination unit 40. For example, the conveying mechanism 60 is able to convey the paper currency 15 from the reception unit 30 to the cassettes 20B to 20E via the determination unit 40 by causing the paper currency 15 to pass through the conveying paths 61A, 61B, 61D, 61H, 61I, 61K, and 61M. Further, the conveying mechanism 60 is able to convey the paper currency 15 from the reception unit 30 to the cassette 20A via the determination unit 40 by causing the paper currency 15 to pass through the conveying paths 61A, 61B, 61D, 61H, 61I, 61J, and 61L.

Furthermore, the conveying mechanism 60 is able to convey the paper currency 15 from one of the cassettes 20 to any other one of the cassettes 20 via the determination unit 40. For example, the conveying mechanism 60 is able to convey the paper currency 15 between the cassette 20A and each of the cassettes 20B to 20E via the determination unit 40 by causing the paper currency to pass through the conveying paths 61L, 61C, 61B, 61D, 61H, 61I, 61K, and 61M. The conveying mechanism 60 includes the conveying paths 61A to 61H as described above in order to cause the paper currency 15 to pass through the determination unit 40 when handling the paper currency 15.

The paper currency handling apparatus 10 includes a control unit 70 that controls the entire apparatus. The control unit 70 is, for example, a computer, and includes a central processing unit (CPU), a random access memory (RAM), a read only memory (ROM), an auxiliary storage device, and the like. The control unit 70 is electrically connected to each of the reception unit 30, the determination unit 40, the temporary holding unit 50, and the conveying mechanism 60. The control unit 70 controls, with the CPU, the reception unit 30, the determination unit 40, the temporary holding unit 50, and the conveying mechanism 60 on the basis of a program and various kinds of data that are stored in the ROM or the auxiliary storage device, and controls various kinds of operation, such as deposit of a paper currency, withdrawal of a paper currency, and detailed examination on a paper currency. The control unit 70 controls the conveying mechanism 60 such that the paper currency 15 passes through the determination unit 40 when performing operation, such as deposit, withdrawal, or detailed examination, for handling the paper currency 15.

Operation of Paper Currency Handling Apparatus

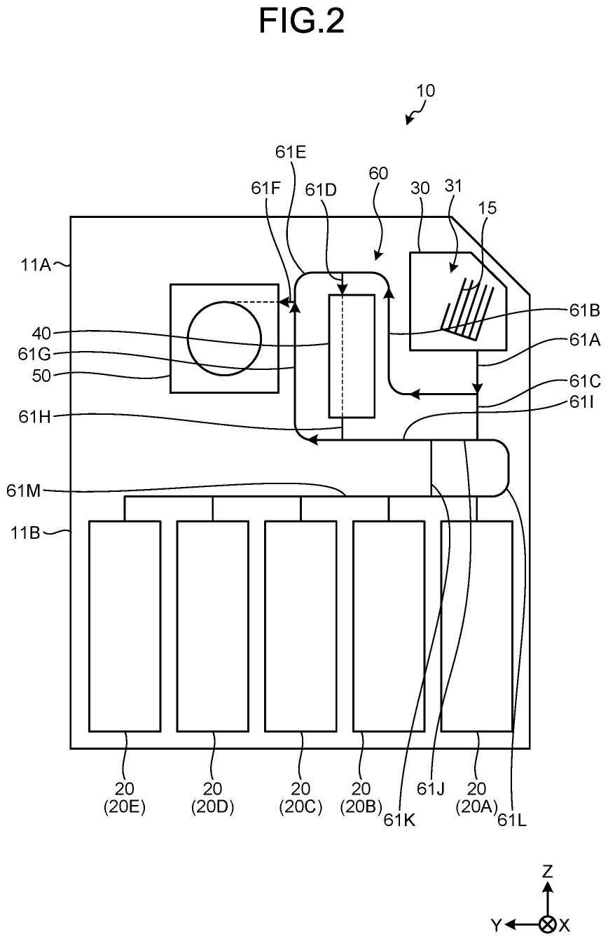

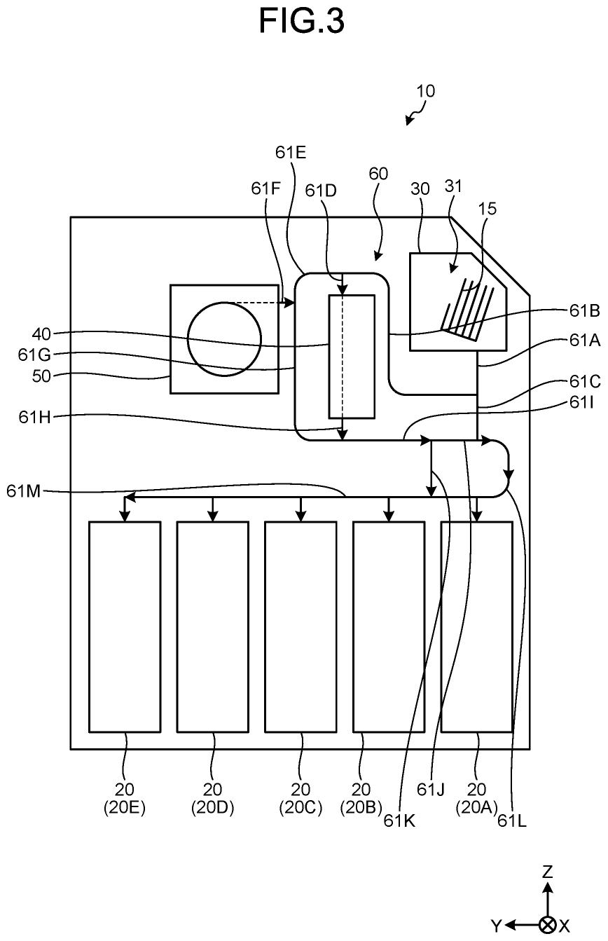

Operation of the paper currency handling apparatus 10 configured as described above will be described below. First, operation of depositing the paper currency 15 will be described. Meanwhile, in each of the drawings below, illustration of the configuration of portions related to the control unit 70 is omitted. FIG. 2 and FIG. 3 are diagrams illustrating examples of a flow of paper currencies at the time of deposit. The reception unit 30 receives, in the storage space 31, the paper currencies 15 from a user. In the case of deposit operation, the control unit 70 controls the conveying mechanism 60 and acquires the paper currencies 15 stored in the storage space 31 one by one. As illustrated in FIG. 2, the control unit 70 causes the conveying mechanism 60 to convey the acquired paper currency 15 to the determination unit 40 via the conveying paths 61A, 61B, and 61D, and causes the determination unit 40 to determine types of the paper currencies 15.

The control unit 70 causes the conveying mechanism 60 and the temporary holding unit 50 to convey the paper currencies 15, for which the types are determined by the determination unit 40, to the temporary holding unit 50 via the conveying paths 61H, 61G, and 61F, and temporarily holds the paper currency 15 in the temporary holding unit 50. The control unit 70 displays information in accordance with a determination result obtained by the determination unit 40 on the operation panel of the reception unit 30. For example, the control unit 70 displays denominations on the basis of the types of the paper currencies 15. Upon receiving, on the operation panel, operation indicating that the denominations are wrong or operation of stopping deposit from the user, the control unit 70 conveys the paper currencies 15 held in the temporary holding unit 50 to the storage space 31 of the reception unit 30 through a route opposite to the route used at the time of deposit.

In contrast, upon receiving, on the operation panel, operation indicating that the denominations are correct from the user, the control unit 70 causes the conveying mechanism 60 and the temporary holding unit 50 to extract the paper currencies 15 that are temporarily held in the temporary holding unit 50 as illustrated in FIG. 3. The control unit 70 causes the conveying mechanism 60 to convey the extracted paper currencies 15 to the determination unit 40 via the conveying paths 61F, 61E, and 61D, and causes the determination unit 40 to determine the types of the paper currencies 15 again. The control unit 70 causes the conveying mechanism 60 to store the paper currencies 15, for which the types are determined by the determination unit 40, in the cassettes 20 for the respective types of the paper currencies 15. For example, the control unit 70 stores the paper currencies 15 in the different cassettes 20 for the respective denominations, such as 10,000 yen bill, 5,000 yen bill, and 1,000 yen bill. Meanwhile, the control unit 70 may separately store the paper currencies 15 of the same type in the plurality of cassettes 20.

The control unit 70 causes the conveying mechanism 60 to convey the paper currencies 15, for which the types are determined by the determination unit 40, to the cassettes 20B to 20E via the conveying paths 61H, 61I, 61K, and 61M. Further, the control unit 70 causes the conveying mechanism 60 to convey the paper currencies 15, for which the types are determined by the determination unit 40, to the cassette 20A via the conveying paths 61H, 61I, 61J, and 61L. Meanwhile, the control unit 70 may cause the conveying mechanism 60 to convey the paper currencies 15, for which the types are determined by the determination unit 40, to the cassettes 20B to 20E via the conveying paths 61H, 61I, 61J, 61L, and 61M.

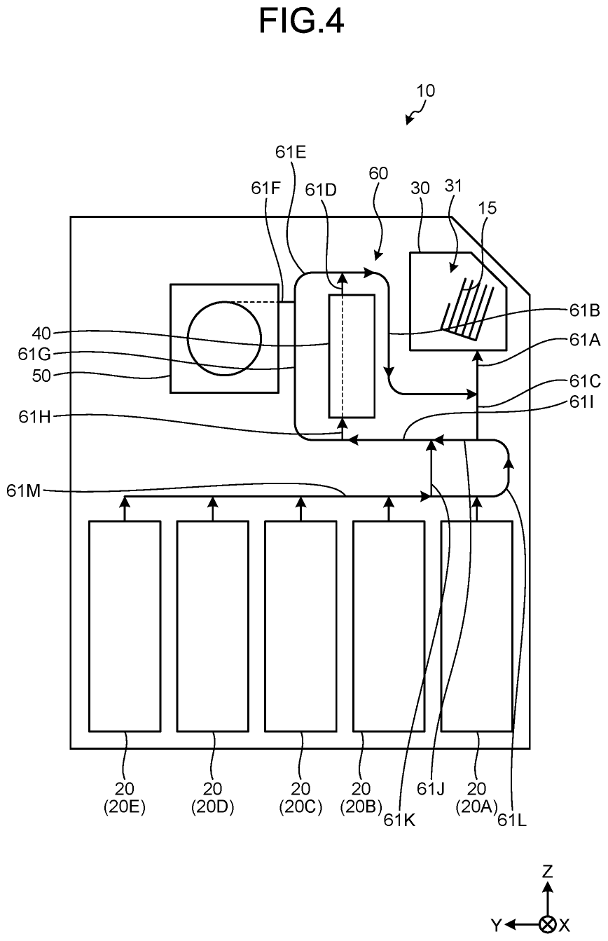

Next, operation at the time of withdrawal of the paper currencies 15 will be described. FIG. 4 is a diagram illustrating an example of the flow of paper currencies at the time of withdrawal. Upon receiving, on the operation panel, operation of withdrawal from the user, the control unit 70 identifies a combination of the paper currencies 15 corresponding to a designated denomination. If the identified paper currencies 15 are stored in the cassettes 20B to 20E, the control unit 70 causes the conveying mechanism 60 to extract the paper currencies 15 one by one from the cassettes 20B to 20E. The control unit 70 causes the conveying mechanism 60 to convey the extracted paper currencies 15 to the determination unit 40 via the conveying paths 61M, 61K, 61I, and 61H, and causes the determination unit 40 to determine the types of the paper currencies 15.

Further, if the identified paper currencies 15 are stored in the cassette 20A, the control unit 70 causes the conveying mechanism 60 to extract the paper currencies 15 one by one from the cassette 20A. The control unit 70 causes the conveying mechanism 60 to convey the extracted paper currency 15 to the determination unit 40 via the conveying paths 61L, 61J, 61I, and 61K, and causes the determination unit 40 to determine the types of the paper currencies 15. Meanwhile, the control unit 70 may convey the paper currencies 15 stored in the cassettes 20B to 20E to the determination unit 40 via the conveying paths 61M, 61L, 61J, 61I, and 61H. The control unit 70 causes the conveying mechanism 60 to convey the paper currencies 15, for which the types are determined by the determination unit 40, to the storage space 31 of the reception unit 30 via the conveying paths 61D, 61B, and 61A.

Next, operation of storing the paper currencies 15 in the cassette 20A that is the reject cassette when a jam occurs in the conveying path 61 will be described. For example, the control unit 70 causes the conveying mechanism 60 to store, in the cassettes 20B to 20E, the paper currencies 15 that are temporarily held in the temporary holding unit 50 at the time of deposit. In this case, it is assumed that the paper currencies 15 that have passed through the determination unit 40 are conveyed to the cassettes 20B to 20E via the conveying paths 61H, 61I, 61J, 61L, and 61M.

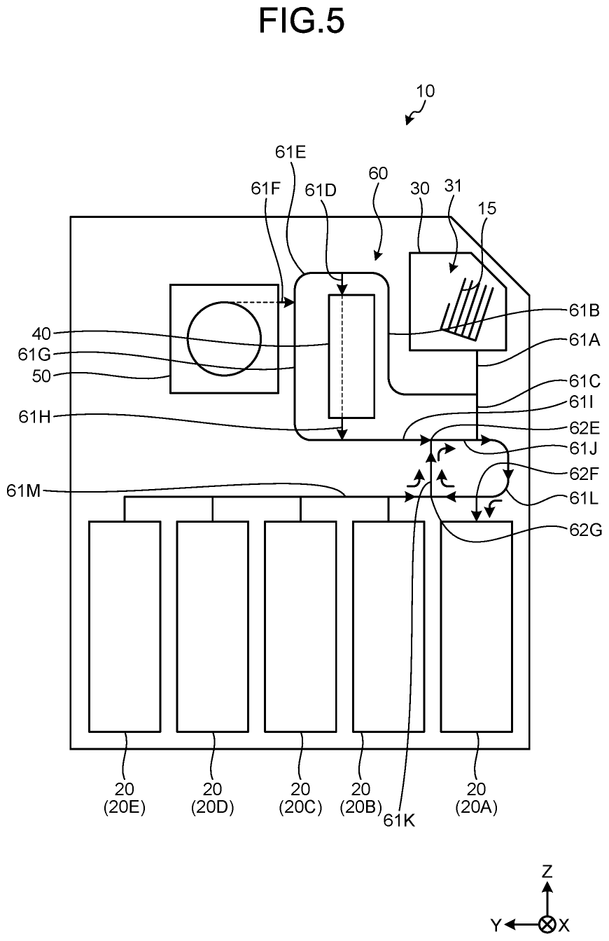

Here, it is assumed that the control unit 70 has detected occurrence of a jam in any of the conveying paths 61F, 61E, 61D, 61H, 61I, 61J, 61L, and 61M. FIG. 5 is a diagram illustrating an example of a flow of paper currencies at the time of occurrence of a jam. As illustrated in FIG. 5, if the jam has occurred, the control unit 70 causes the conveying mechanism 60 to store the paper currencies 15 on the conveying path in the cassette 20A.

In this case, conveying directions of the conveying path 61L and the conveying path 61M are opposite to each other. In other words, at the bifurcation point 62G, a conveyance route from the conveying path 61L to the conveying path 61K and a conveying route from the conveying path 61M to the conveying path 61K are joined together. Further, the conveying paths 61J, 61L, and 61K form a loop. At the bifurcation point 62G serving as a joint portion of the three conveying paths as described above, a conveying direction switching apparatus 80 is installed as a switching mechanism.

Here, a case will be described in which the switching mechanism at the bifurcation point 62G is configured such that, as illustrated in Patent Document 1 for example, toe sides of the two switching claws face each other. In this case, the routes from the conveying path 61L and the conveying path 61K, the conveying directions of which are opposite to each other, toward the conveying path 61K overlap with each other. Therefore, the paper currencies 15 that are stuck between the bifurcation points 62F and 62G of the conveying path 61M and the conveying path 61L crash into back sides of the switching claws and it becomes difficult to perform conveyance.

In contrast, the conveying direction switching apparatus 80 according to the present embodiment includes a first switching gate that switches between a first conveyance route connecting the conveying path 61M and the conveying path 61L and a second conveyance route connecting the conveying path 61M and the conveying path 61K. Further, the conveying direction switching apparatus 30 includes a second switching gate that switches between the first conveyance route connecting the conveying path 61M and the conveying path 61L and a third conveyance route connecting the conveying path 61L and the conveying path 61K. The first switching gate and the second switching gate are arranged such that respective shaft sides are arranged back-to-back. Therefore, the conveying direction switching apparatus 80 is able to switch between the second conveyance route connecting the conveying path 61M and the conveying path 61K and the third conveyance route connecting the conveying path 61L and the conveying path 61K such that the routes do not overlap with each other. The conveying direction switching apparatus 30, when a jam occurs, is able to store the paper currencies 15 remaining on the conveying paths 61J, 61L, and 61M in the cassette 20A by switching between the second conveyance route and the third conveyance route such that passage through the both routes can be allowed.

Configuration of Conveying Direction Switching Apparatus

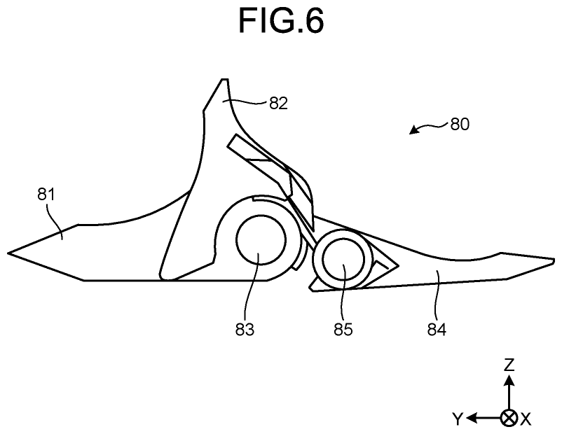

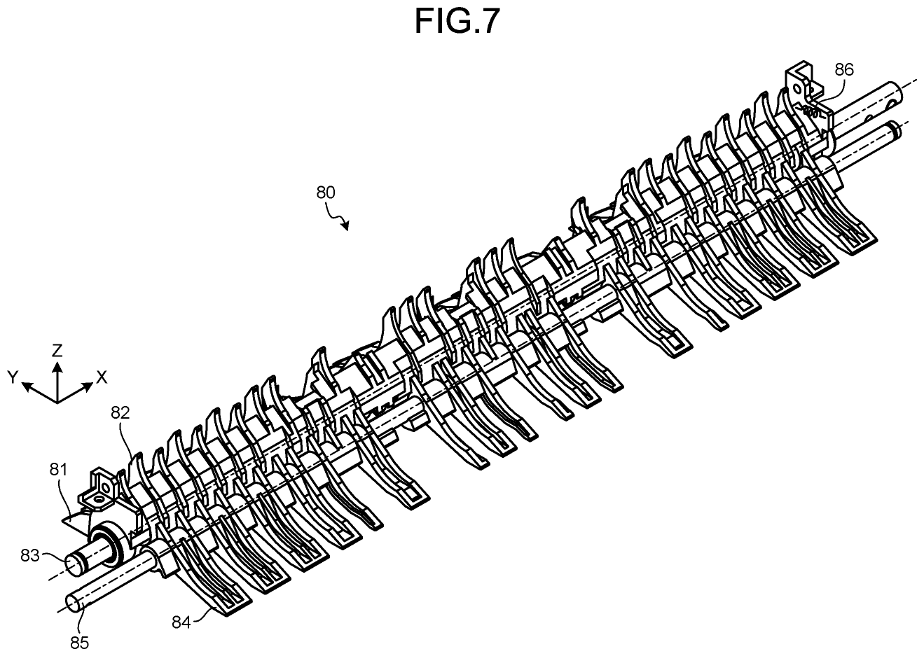

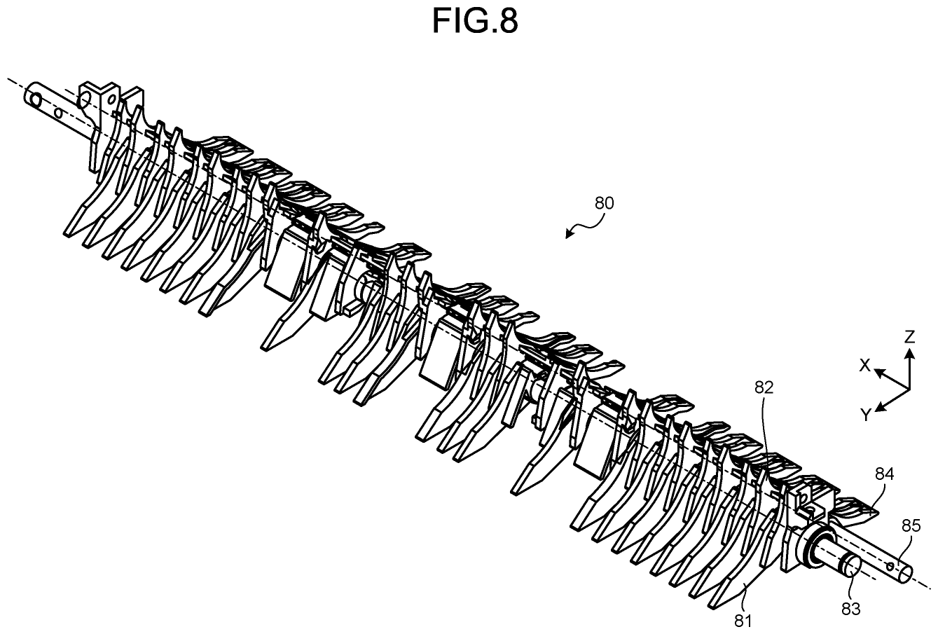

A configuration of the conveying direction switching apparatus 80 will be described below with reference to FIG. 6 to FIG. 8. FIG. 6 is a side view illustrating one example of the conveying direction switching apparatus according to the embodiment. FIG. 7 is a perspective view illustrating one example of the conveying direction switching apparatus according to the embodiment when viewed from a front side. FIG. 8 is a perspective view illustrating one example of the conveying direction switching apparatus according to the embodiment when viewed from a back side.

As illustrated in FIG. 6 to FIG. 8, the conveying direction switching apparatus 80 includes a first switching gate 81, a free gate 82, a shaft 83, a second switching gate 84, a shaft 85, and a spring 86. The first switching gate 31 and the free gate 82 are supported by the shaft 83 in a coaxial manner and in a rotatable manner. The shaft 83 is rotatable in both of forward and backward with use of a motor (not illustrated) controlled by the control unit 70, and causes the first switching gate 81 fixed to the shaft 83 to rotate to switch between conveyance routes. The second switching gate 84 is supported by the shaft 85 in a rotatable manner. The shaft 85 is rotatable in both of forward and backward directions with use of a motor (not illustrated) controlled by the control unit 70, and causes the second switching gate 84 fixed to the shaft 85 to rotate to switch between conveyance routes. The first switching gate 81 is a switching gate that switches between the first conveyance route and the second conveyance route as described above. The first switching gate 81 has a plurality of claws, which have the same shapes when viewed in an X direction of the conveying direction switching apparatus 80, in the X direction, where a distal end of each of the claws is oriented in a positive direction of a Y axis and switches between the conveying directions of the paper currency 15 to be conveyed.

The second switching gate 84 is a switching gate that switches between the first conveyance route and the third conveyance route as described above. The second switching gate 84 has a plurality of claws, which have the same shapes when viewed in the X direction of the conveying direction switching apparatus 80, in the X direction, where a distal end of each of the claws is oriented in a negative direction of the Y axis and switches between the conveying directions of the paper currency 15 to be conveyed. In other words, the first switching gate 81 and the second switching gate 84 are arranged such that the shaft 83 and the shaft 85 are arranged back-to-back.

The free gate 82 is a switching gate that switches between the second conveyance route and the third conveyance route. The free gate 82 has a plurality of claws, which have the same shapes when viewed in the X direction of the conveying direction switching apparatus 80 in the X direction, where a distal end of each of the claws is oriented in a positive direction of a Z axis. The free gate 82 is not fixed to the shaft 83, and is freely rotatable independent of rotation of the shaft 83. Further the free gate 82 is held by the spring 86 such that a second conveyance route side is opened. The spring 86 is one example of an elastic body. The conveying direction switching apparatus 80, with the configuration as described above, is able to reduce a size of the paper currency handling apparatus 10 in a height direction.

Operation of Conveying Direction Switching Apparatus

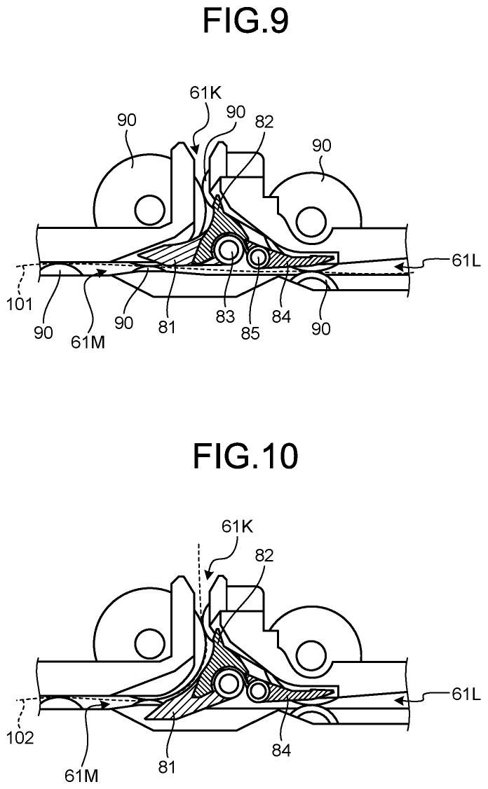

Operation of the conveying direction switching apparatus 80 will be described below with reference to FIG. 9 to FIG. 12. FIG. 9 is a side view illustrating one example of an operating state of the conveying direction switching apparatus according to the embodiment. A state illustrated in FIG. 9 is a state in which both of the first switching gate 81 and the second switching gate 84 are switched to a first conveyance route 101 side. In this case, the paper currency 15 conveyed from the conveying path 61M by each of conveying rollers 90 is conveyed to the conveying path 61L. Further, the paper currency 15 conveyed from the conveying path 61L by each of the conveying rollers 90 is conveyed to the conveying path 61M. At this time, when viewed from the conveying path 61K side, the second conveyance route side is closed by the first switching gate 81, and the third conveyance route side is closed by the free gate 82.

FIG. 10 is a side view illustrating another example of the operating state of the conveying direction switching apparatus according to the embodiment. A state illustrated in FIG. 10 is a state in which the first switching gate 81 is switched to a second conveyance route 102 side and the second switching gate 84 is switched to the first conveyance route 101 side. In this case, the paper currency 15 conveyed from the conveying path 61M by each of the conveying rollers 90 is conveyed to the conveying path 61K. Further, when viewed from the conveying path 61K side, the third conveyance route side is closed by the free gate 82, so that the paper currency 15 conveyed from the conveying path 61K by each of the conveying rollers 90 is conveyed to the conveying path 61M.

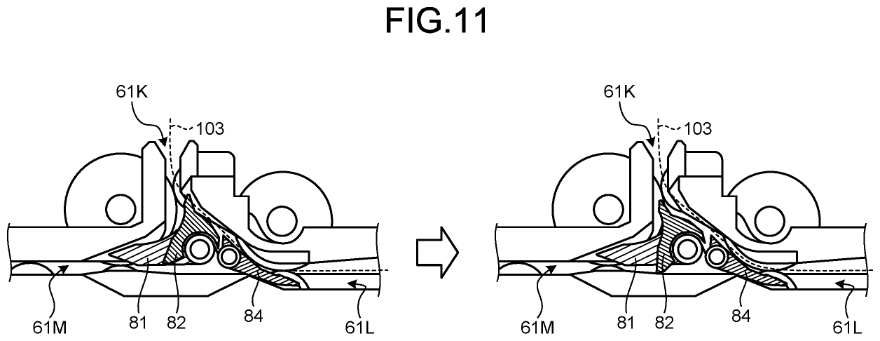

FIG. 11 is a side view illustrating a still another example of the operating state of the conveying direction switching apparatus according to the embodiment. A state illustrated in FIG. 11 is a state in which the first switching gate 81 is switched to the first conveyance route 101 side and the second switching gate 84 is switched to a third conveyance route 103 side. In this case, when viewed from the conveying path 61K side, the second conveyance route side is closed by the first switching gate 81 and the third conveyance route side is closed by the free gate 82. Here, if the paper currency 15 is conveyed from the conveying path 61L by each of the conveying rollers 90, the free gate 82 is pushed open in the positive direction of the Y axis by the paper currency 15, and the paper currency 15 is conveyed to the conveying path 61K. The free gate 82, after the paper currency 15 conveyed from the conveying path 61L has passed, is held in a state in which the second conveyance route 102 side is opened again due to the action of the spring 86.

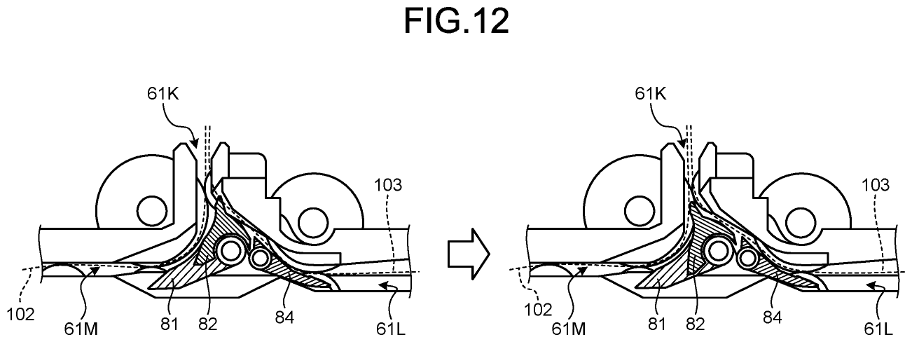

FIG. 12 is a side view illustrating a still another example of the operating state of the conveying direction switching apparatus according to the embodiment. A state illustrated in FIG. 12 is a state of the conveying direction switching apparatus 80 in a case in which the conveying directions of the conveying path 61M and the conveying path 61L are opposite to each other in order to store the paper currency 15 on the conveying path 61 in the cassette 20A when a jam occurs. The state illustrated in FIG. 12 is a state in which the first switching gate 81 is switched to the second conveyance route 102 side and the second switching gate 84 is switched to the third conveyance route 103 side. In this case, the paper currency 15 conveyed from the conveying path 61M by each of the conveying rollers 90 is conveyed to the conveying path 61K. In contrast, if the paper currency 15 is conveyed from the conveying path 61L by each of the conveying rollers 90, the free gate 82 is pushed open in the positive direction of the Y axis by the paper currency 15, and the paper currency 15 is conveyed to the conveying path 61K. The free gate 82, after the paper currency 15 conveyed from the conveying path 61L has passed, is held in a state in which the second conveyance route 102 is opened due to the action of the spring 86.

Further, when the jam is to be recovered, in some cases, the paper currencies 15 may simultaneously be conveyed from both of the conveying path 61M and the conveying path 61L. The free gate 82 is pushed open in the positive direction of the Y axis by the paper currency 15 conveyed from the conveying path 61L on the third conveyance route 103 side. In this case, a width of the conveying path 61K is adequately wide as compared to a thickness of the paper currency 15, so that even if the paper currency 15 that is currently pushing open the free gate 82 from the conveying path 61L side is present, a width enough to allow passage of the paper currency 15 is ensured on the second conveyance route 102 side. Therefore, even if the paper currencies 15 simultaneously reach the free gate 82 from both of the conveying path 61M and the conveying path 61L, both of the paper currencies 15 are conveyed to the conveying path 61K. Meanwhile, at this time, the two paper currencies 15 overlap with each other, but they are stored as they are in the cassette 20A that is the reject cassette, so that there is no problem.

As described above, the conveying direction switching apparatus 80 includes the first switching gate 81, the second switching gate 84, and the free gate 82. The first switching gate 81 switches between the first conveyance route 101 connecting the first conveying path and the second conveying path and the second conveyance route 102 connecting the first conveying path and the third conveying path at the joint portion of the first conveying path (61M), the second conveying path (61L), and the third conveying path (61K). The second switching gate 84 switches between the first conveyance route 101 and the third conveyance route 103 connecting the second conveying path and the third conveying path. The free gate 82 is arranged on the same shaft as the first switching gate 81 such that the second conveyance route 102 side is opened by the elastic member at a joint portion of the second conveyance route 102 and the third conveyance route 103. The conveying direction switching apparatus 80, when the conveying directions of the first conveying path and the second conveying path are opposite to each other, switches the first switching gate 81 to the second conveyance route 102 side and switches the second switching gate 84 to the third conveyance route 103 side. As a result, it is possible to remove the paper currencies in the conveying paths whose conveying directions are opposite to each other. Further, it is possible to reduce the size of the conveying direction switching apparatus 80 at the joint portion of the three conveying paths.

Furthermore, in the conveying direction switching apparatus 80, the first switching gate 81 and the second switching gate 84 are arranged such that respective shaft sides where the first switching gate 81 and the second switching gate 84 are supported face each other. As a result, it is possible to reduce the size of the conveying direction switching apparatus 80 at the joint portion of the three conveying paths.

Moreover, in the conveying direction switching apparatus 80, the second conveyance route 102 and the third conveyance route 103 are routes that do not overlap with each other on routes to the joint portion of the second conveyance route 102 and the third conveyance route 103. As a result, even if the paper currencies 15 are simultaneously conveyed from both of the second conveyance route 102 and the third conveyance route 103, it is possible to convey the paper currencies to the third conveying path as a conveyance destination.

Furthermore, in the conveying direction switching apparatus 80, if the paper sheet (the paper currency 15) to be conveyed is conveyed from the second conveying path to the third conveying path side on the third conveyance route 103, the paper sheet pushes open the free gate 82 and is conveyed to the third conveying path side. As a result, in the third conveyance route 103, it is possible to convey the paper sheet from the second conveying path to the third conveying path side.

Moreover, the paper currency handling apparatus 10 includes the holding unit, the cassettes, the reject cassette, the conveying path, and the conveying direction switching apparatus 80. The holding unit (the temporary holding unit 50) temporarily holds the received paper sheet (the paper currency 15). The cassettes (the cassettes 20B to 20E) store therein the paper sheet that is held in the holding unit. The reject cassette (the cassette 20A) stores therein one or more paper sheets among paper sheets that are not appropriate to be stored in the cassettes and paper sheets that are not appropriate to be output. The conveying path (61) includes the first conveying path (61M) that is located at the side of the cassettes to which the paper sheet is conveyed, the second conveying path (61L) that is located at the side of the reject cassette, and the third conveying path (61K) that forms a loop with the second conveying path. The conveying direction switching apparatus 80 switches between conveying directions of the paper sheet at the joint portion (the bifurcation point 62G) of the first conveying path, the second conveying path and the third conveying path. The conveying direction switching apparatus 80 includes the first switching gate 81 the second switching gate 84, and the free gate 82. The first switching gate 81 switches between the first conveyance route 101 connecting the first conveying path and the second conveying path and the second conveyance route 102 connecting the first conveying path and the third conveying path at the joint portion of the first conveying path, the second conveying path, and the third conveying path. The second switching gate 84 switches between the first conveyance route 101 and the third conveyance route 103 connecting the second conveying path and the third conveying path. The free gate 82 is arranged on the same shaft as the first switching gate 81 such that the second conveyance route 102 side is opened by the elastic body at the joint portion of the second conveyance route 102 and the third conveyance route 103. The conveying direction switching apparatus 80, if the conveying directions of the first conveying path and the second conveying path are opposite to each other, switches the first switching gate 81 to the second conveyance route 102 side and switches the second switching gate 84 to the third conveyance route 103 side. As a result, it is possible to remove the paper currencies on the conveying paths whose conveying directions are opposite to each other.

Meanwhile, in the present embodiment, the case has been described in which the paper currency 15 is adopted as the paper sheet, but embodiments are not limited to this example. For example, the paper sheet may be various negotiable instruments, such as a bill, a check, a money coupon, various securities, and a stock certificate.

Furthermore, in the present embodiment, the case has been described in which the conveying direction switching apparatus 80 is adopted at the bifurcation point 62G in the conveying mechanism 60 of the paper currency handling apparatus 10, but embodiments are not limited to this example. For example, it may be possible to apply the apparatus at a different bifurcation point of the conveying mechanism 60 as long as the bifurcation point is a joint portion of the three conveying paths, or at a bifurcation point of conveying paths in a different apparatus that handles a paper sheet.

It is possible to remove paper currencies in conveying paths whose conveying directions are opposite to each other.

All examples and conditional language provided herein are intended for the pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A conveying direction switching apparatus comprising:
a first switching gate that, at a joint portion of a first conveying path, a second conveying path, and a third conveying path, switches between a first conveyance route connecting the first conveying path and the second conveying path and a second conveyance route connecting the first conveying path and the third conveying path;
a second switching gate that switches between the first conveyance route and a third conveyance route connecting the second conveying path and the third conveying path; and
a free gate that is arranged on a same shaft as the first switching gate such that a second conveyance route side is opened by an elastic body at a joint portion of the second conveyance route and the third conveyance route, wherein
when conveying directions of the first conveying path and the second conveying path are opposite to each other, the first switching gate is switched to the second conveyance route side and the second switching gate is switched to a third conveyance route side.

2. The conveying direction switching apparatus according to claim 1, wherein the first switching gate and the second switching gate are arranged such that respective shafts sides where the first switching gate and the second switching gate are supported face each other.

3. The conveying direction switching apparatus according to claim 1, wherein the second conveyance route and the third conveyance route are routes that do not overlap with each other on routes to the joint portion of the second conveyance route and the third conveyance route.

4. The conveying direction switching apparatus according to claim 1, wherein when a paper sheet to be conveyed is convened from the second conveying path to a third conveying path side on the third conveyance route, the paper sheet pushes open the free gate and is conveyed to the third conveying path side.

5. A paper sheet handling apparatus comprising:
a holder configured to temporarily hold a received paper sheet;
a cassette that stores therein the paper sheet that is held in the holder;
a reject cassette that stores therein one or more paper sheets among paper sheets that are not appropriate to be stored in the cassette and paper sheets that are not appropriate to be output;
a first conveying path that is located at a side of the cassette to which the paper sheet is conveyed;
a second conveying path that is located at a side of the reject cassette;
a third conveying path that forms a loop with the second conveying path; and
a conveying direction switching apparatus that switches between conveying directions of the paper sheet at a joint portion of the first conveying path, the second conveying path, and the third conveying path, wherein
the conveying direction switching apparatus includes:
a first switching gate that switches between a first conveyance route connecting the first conveying path and the second conveying path and a second conveyance route connecting the first conveying path and the third conveying path,
a second switching gate that switches between the first conveyance route and a third conveyance route connecting the second conveying path and the third conveying path, and
a free gate that is arranged on a same shaft as the first switching gate such that a second conveyance route side is opened by an elastic body at a joint portion of the second conveyance route and the third conveyance route, and
when conveying directions of the first conveying path and the second conveying path are opposite to each other, the first switching gate is switched to the second conveyance route side and the second switching gate is switched to a third conveyance route side.
